(19) United States
(12) Patent Application Publication
(10) Pub. No.: US 2004/0265699 A1
(43) Pub. Date: Dec. 30, 2004

(54) Eletrode for lead srorage battery and method for manufacturing thereof

(76) Inventors: Seok-Mo Choi, Daejon (KR); Kwang-Seok Kim, Daejon (KR); Young-Sup Shim, Daejon (KR)

Correspondence Address: Robert E Krebs, Thelen Reid & Priest, P O Box 640640, San Jose, CA, 95164-0640, US

(21) Appl. No.: 10/483,332

(22) PCT Filed: Jul. 9, 2002
(86) PCT No.: PCT/KR02/01296

(30) Foreign Application Priority Data
Jul. 10, 2001 (KR) 2001/41206

(51) Int. Cl. H01M 2/18; H01M 2/16; H01M 4/04

(52) U.S. Cl. 429/246; 29/623.5; 429/129

(57) ABSTRACT

A lead storage battery electrode and a method for manufacturing the same are provided. The lead storage battery electrode includes a substrate, which is casted or expanded using lead, an active material coated on the substrate with electrochemical activities, and support layers and formed by embedding porous nonwoven fabric to a predetermined depth from both surfaces of the active material. The support layers prevent the separation of the active material in the manufacture of the electrode and make handling the active material easier. The porosity of the nonwoven fabric enhances the initial high rate discharge properties of the electrode, and the network structure of the nonwoven fabric, which is acid-resistant, stably supports the active material, so that the life cycle of the lead storage battery is prolonged.

### BACKGROUND OF THE INVENTION

### CROSS-REFERENCE TO RELATED APPLICATION

This application claims priority based on International Patent Application No. PCT/KR02/01296, entitled “Electrode for Lead Storage Battery and Method for Manufacturing Thereof” by Kwang Seok Kim, Young Sup Shim, and Seok Mo Choi, which claims priority to Korean Patent Application No. 2001-41206, filed on Jul. 10, 2001.

1. Field of the Invention

The present invention relates to a lead storage battery electrode and a method for manufacturing the same, and more particularly, to a method for manufacturing an electrode for a lead storage battery by attaching porous nonwoven fabric to both surfaces of the electrode.

2. Description of the Related Art

Lead storage batteries are widely known as secondary rechargeable batteries used in most vehicles. In a lead storage battery, a dilute solution of sulfuric acid is used as the electrolyte, the positive electrode is coated with an active material, lead dioxide (PbO₂), and the negative electrode is coated with an active material, spongy lead. As the lead storage battery is connected to an external circuit, electrons travel through the external circuit, and the positive and negative active materials combine to form lead sulfite (PbSO₄) (charging mode). As an electric current is flowed into the lead storage battery, the lead sulfite changes into lead dioxide (discharging mode). The lead storage battery operates based on these principles.

The structure of such a lead storage battery is illustrated in FIG. 1. A plurality of positive electrode plates 1 and negative electrode plates 2, each of which is coated with the active material, alternately overlap, with an insulating separator 3 between each of the positive and negative electrode plates 1 and 2. One positive electrode plate 1, one insulating separator 3, and one negative electrode plate 2 constitute an element of electrode plates. A plurality of electrode plate elements are connected in series according to the capacity of the lead storage battery and are accommodated in a battery case 4 together with the electrolyte.

Positive and negative electrode plates can be classified into various types according to the method of manufacturing the same. As one example, a paste type electrode is shown in FIG. 2. The paste type electrode comprises a grid substrate 5 and a paste active material 6 coated on the substrate 5. The substrate 5 is formed of a soft alloy containing a trace of calcium for enhancing the mechanical strength of the substrate 5. In general, the substrate 5 is formed by gravity casting by pouring a melted alloy into a mold or by continuous rolling, as disclosed in Korean Laid-open Patent Publication No. 2000-0031876. The active material 6, which is crucial to the performance of the lead battery, is prepared as the paste by mixing lead oxide in micro-particle form with a dilute sulfuric acid solution. The paste is continuously deposited on the substrate 5 using an apparatus and subjected to aging, drying, and electrical oxidation and reduction (formation) to become the active material 6 (Korean Patent Nos. 10-250866 and 10-0266133.

The lead dioxide (PbO₂), the active material of the positive electrode plate 1, deposited on the positive electrode plate 1 is in micro-particle form, so that the electrolyte is allowed to diffuse and permeate through the lead dioxide microparticles on the positive electrode plate 1. The spongy lead, the active material of the negative electrode plate 2, is porous and reactive, so that the electrolyte is allowed to diffuse and permeate through the sponge lead on the negative electrode plate 2.

However, since the active materials are deposited in paste form, the active materials may be easily released from the electrode plates. Furthermore, after rapid drying or when the electrode plates are stacked upon one another after being manufactured, adjacent electrode plates stick to each other, so that the surface of the electrode plates deposited with the active materials may become rough.

In order to prevent the separation of the active materials from the electrode plates and to ensure easy handling of the active materials in the manufacture of electrodes, paper has been adhered as a support to the active materials after deposition. However, the paper dissolves in the electrolyte contained in the battery case in a formation process, which is an ultra initial charging process performed immediately after electrode assembly, or during use of the battery.

However, the paper used in the manufacture of electrodes blocks diffusion and permeation of the electrolyte into the active material particles because it is non-porous and degrades the high rate discharge properties at an early stage of use of the battery where the dissolution of the paper is not complete. In addition, when the paper completely dissolves in the electrolyte, organic substances are generated to form a local cell, thereby accelerating self-discharging and shortening the lifetime of the storage battery.

### SUMMARY OF THE INVENTION

As described above, in the manufacture of paste type electrodes, preventing the active materials from being easily separated from the electrode plates and enhancing the porosity of the active materials in order to prevent degradation of the high rate discharge properties of the battery at an early stage of use are important concerns. In addition, there is a need to suppress the generation of organic substances causing side reactions in the electrolyte.

Accordingly, the invention provides a lead storage battery electrode and a method for manufacturing the lead storage battery electrode, in which porous nonwoven fabric having micron-sized pores, instead of paper, is embedded into active materials in order to prevent the separation and handling problems of the active materials and initial high rate discharge degradation, which are encountered when the non-porous paper is used. The porous nonwoven fabric allows easy ion transfer by capillarity and thus improves the initial high rate discharge properties. The porous nonwoven fabric permanently supports the active materials, thereby increasing the lifetime of the electrode plates and the battery.

In an aspect, the invention provides a lead storage battery electrode comprising: a substrate casted using lead; and an active material coated on the substrate with electrochemical activities, the active material having a support layer formed of porous nonwoven fabric on its surface.

In another aspect, the invention provides a method for manufacturing a lead storage battery electrode, comprising: coating an electrode substrate casted of lead with an active material having electrochemical activities, attaching porous nonwoven fabric to the surface of the active material layer, pressing the porous nonwoven fabric to be embedded to a predetermined depth from the surface of the active layer; and drying the active material to which the porous nonwoven fabric has been attached or embedded using hot air prior to formation of the active material.

The nonwoven fabric used in the lead storage battery electrode according to the present invention should be hydrophilic and preferably, has a strong tensile strength of 5-30N at 10 Kgf and a small thickness of 0.01-0.3 mm, to replace paper used in conventional electrodes. It is preferable that the nonwoven fabric comprise 1-20 μm long-fabric filaments having a L/D ratio of 200 or greater for smooth ion transfer and stable support of the active material.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded sectional view showing the internal structure of a general lead storage battery;

FIG. 2 is an exploded side view of the general lead storage battery;

FIG. 3 is a view for illustrating a method for manufacturing a lead storage battery electrode according to the present invention;

FIG. 4 is a partial sectional view of a lead storage battery electrode manufactured according to the present invention; and

FIG. 5 is a graph showing the results of a cycle life test on a lead storage battery according to the present invention.

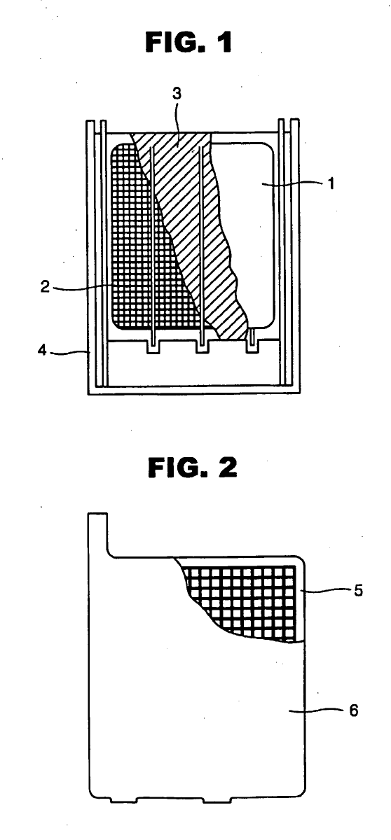

### DETAILED DESCRIPTION OF THE INVENTION

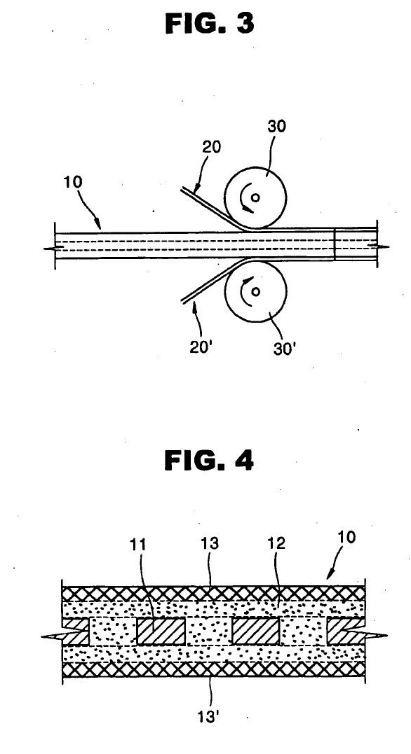

In a method for manufacturing a lead storage battery electrode according to the present invention, predetermined nonwoven fabrics 20 and 20′ are continuously applied to both surfaces of an electrode 10 coated with an active material, and an appropriate pressure is applied to the nonwoven fabrics 20 and 20′ using pressure rollers 30 and 30′ while the electrode 10 is moved, as shown in FIG. 3. An apparatus for manufacturing the lead storage battery electrode according to the present invention can be implemented by simply connecting a nonwoven fabric applying apparatus and the pressure rollers to a conventional active material coating apparatus.

Drying and formation processes following the attachment of the nonwoven fabrics 20 and 20′ are performed by common methods, and thus descriptions on the drying and formation processes will not be repeated here.

FIG. 4 is a partial sectional view of the lead storage battery electrode according to the present invention, which is formed through the nonwoven fabric attachment, pressing, and general drying and formation processes as described above. In FIG. 4, reference numeral 10 denotes the electrode, reference numeral 11 denotes a grid substrate, reference numeral 12 denotes the active material coated on the substrate 11, and reference numerals 13 and 13′ denote support layers formed by embedding the nonwoven fabrics to a depth from the surface of the active material 12.

The support layers 13 and 13′ provide a tensile strength due to the nonwoven fabric network, which is strong enough to prevent the separation of the active material from the electrode plate, and allows easy diffusion and permeation of the electrolyte due to their porosity. In addition, the support layers 13 and 13′ are acid-resistant and thus stably support the active materials without dissolving in the electrolyte.

Generally, nonwoven fabric refers to a fiber cluster or film produced by combining fibers through physical, chemical, mechanical, or thermal treatment, optionally with an addition of water, instead of being manufactured by spinning, textile manufacturing, or cotton weaving. In the present invention, nonwoven fabrics synthesized from thermoplastic resin by spun-bonding or thermal-bonding are used. The requirements for hydrophilicity, tensile strength, and acid-resistance in coating the active material can be satisfied merely by selection and combination of appropriate source materials. Therefore, the electrode can be easily and economically manufactured in the present invention.

According to the present invention, nonwoven fabrics formed of polyesters, polypropylenes, or viscose rayon are used. Among these materials, polyester-based nonwoven fabrics provide best quality.

To verify this, an electrode was manufactured in the above-described manner. As a result, nonwoven fabric network structures acting as the support layers 13 and 13′ were embedded to a depth of 0.05 mm from the surfaces of the active materials, thereby enhancing the binding strength to the active materials.

Lead storages batteries were assembled using the electrodes manufactured as described above, and an initial performance test and a cycle life test was performed using the lead storage batteries. The results are as follows.

TABLE 1
Initial performance test results

| | Test | | | | | Re- |
|---|---|---|---|---|---|---|
| | Condition | Example 1 | Example 2 | Example 3 | Average | marks |
| RC | 130 min | 130 | 130 | 132 | 131 | |
| | | 100.3% | 100.2% | 101.3% | 100.6% | |
| CP | 7.2 V | 7.85 | 7.88 | 7.64 | 7.79 | |
| | 630 A | 698 | 701 | 676 | 692 | |
| | | 110.8% | 111.3% | 107.3% | 109.8% | 9.8% |
| | | | | | | increase |
| C20 | 75 Ah | 74.9 | 73.6 | 74.0 | 74.2 | |
| | | 99.8% | 98.1% | 98.7% | 98.9% | |

1) Reserve Capacity (RC)

Reserve capacity is to measure the reserve time of a battery on discharge with a current of 25A at 2.5□ after being left one hour from the completion of a full charge until a discharge cut-off voltage reaches 10.5V. In other words, reserve capacity is a measure of the minimum operating duration of the battery required for a load after a vehicle is fully charged and turned off.

As shown in Table 1 above, the lead storage batteries using the nonwoven fabric-embedded electrodes according to the present invention had a reserve capacity of 130-132 minutes, which are slight improvements from conventional batteries using the paper-attached electrodes.

2) Cold Cranking Ampere (CCA)

The fast discharging properties of lead storage batteries rapidly degrade at a temperature less than −10□. Measuring cold cranking ampere (CCA) is a high rate discharge test for evaluating the cracking ability of vehicles at low temperature. After completion of a full charge, a discharge voltage for 30 seconds was measured with a current of 630A at −18□. A 30-second voltage greater than 7.2V is required for lead storage batteries. The greater the 30-second voltage, the better the performance of the battery. In the present invention, CCA was calculated using the formula,

CCA=(30−second voltage÷6−0.2)×630.

As a result, as shown in Table 1 above, the lead storage batteries according to the present invention had a 30-second voltage of 7.64-7.88V and a CCA of 676-701A, which is about 10% increase from conventional lead storage batteries.

3) 20-Hour Rate Capacity (C20)

As a measure of the low rate discharge properties of a battery, the discharge capacity in Ah was measured by continuously discharging the lead storage battery with a current of 3.75A, which is relatively low with respect to the battery capacity, until the voltage of the battery reaches 10.5V. As a result, the 20-hour rate capacity of the lead storage batteries according to the present invention was in the range of 73.6-74.9 Ah, which is almost the same as conventional lead storage batteries using the paper-attached electrodes.

TABLE 2
Cycle life test results (SAE J240 at 75□)

| | 30-second voltage (V) | | | |
|---|---|---|---|---|
| Charge/discharge | Conventional | Conventional | Present | |
| cycles | battery 1 | battery 2 | invention | Remarks |
| 480 | 9.05 | 8.65 | 9.08 | |
| 960 | 8.46 | 8.27 | 8.91 | |
| 1440 | 7.36 | 7.50 | 8.48 | |
| 1920 | 2.82 | 2.92 | 7.87 | |
| 2400 | — | — | 6.20 | |
| Cycle life | 1,920 | 1,920 | 2,400 | 20% increase |

One cycle of the cycle life test was composed of a 4-minute discharge with a current of 25A and a 10-minute charge with a maximum current 25A to 14.8V and required one week to complete. 480 cycles of the charge/discharge were performed, followed by 56-hours on open circuit and a high rate discharge with a current of 630A to measure the 30-second voltage. When the 30-second voltage was greater than 7.2V, the cycle life test was repeated for one week longer. When the 30-second voltage was less than 7.2V, it was considered that the lifetime of the battery ended.

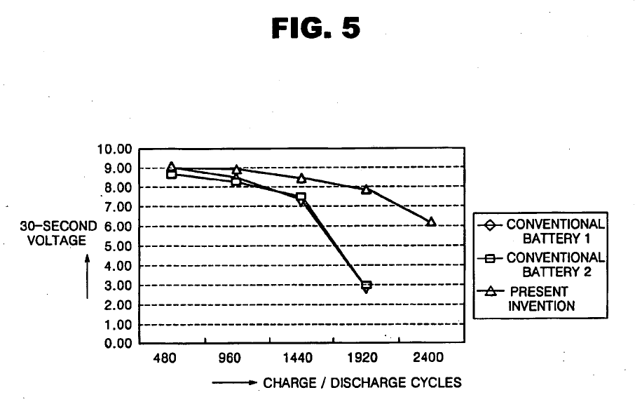

As shown in Table 2 and FIG. 5, the cycle life of the battery according to the present invention was determined to be 2400 cycles, which is a 25% increase from the conventional batteries having the paper-attached electrodes.

As described in the above embodiments, according to the lead storage battery electrode and the method for manufacturing the same in the present invention, the active material coated on the electrode is supported by nonwoven fabric, unlike conventional electrodes supported by paper. As a result, the separation of the active material and any inconvenience in handling the active material can be eliminated. Since the nonwoven fabric, which is porous and acid-resistant, is embedded to a depth from the surface of the active material, the active material on the battery can be stably supported ensuring improved initial high rate discharge properties and prolonged battery lifetime.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A lead storage battery electrode comprising:
a substrate casted using lead; and
an active material coated on the substrate with electrochemical activities, the active material having a support layer formed of porous nonwoven fabric on its surface.

2. The lead storage battery electrode of claim 1, wherein the support layer of the porous nonwoven fabric is embedded to a depth of the active material by pressing.

3. The lead storage battery electrode of claim 1, wherein the porous nonwoven fabric is synthesized from thermoplastic resin by spun-bonding or thermal-bonding.

4. The lead storage battery electrode of claim 3, wherein the thermoplastic resin is at least one selected from the group consisting of polyesters, polypropylenes, and viscos rayon.

5. The lead storage battery electrode of claim 1, wherein the porous nonwoven fabric comprises 1-20 μm long-fabric filaments.

6. A method for manufacturing a lead storage battery electrode in which an electrode substrate casted of lead is coated with an active material having electrochemical activities and subjected to drying and formation for electrical oxidation and reduction, the method comprising attaching porous nonwoven fabric to the surface of the active material after the electrode substrate has been coated with the active material.

7. The method of claim 1, further comprising pressing the attached porous nonwoven fabric to be embedded into the surface of the active material to form a support layer.
